(19) United States
(12) Patent Application Publication
(10) Pub. No.: US 2026/0135717 A1
(43) Pub. Date: May 14, 2026

(54) SYSTEMS AND METHODS FOR IDENTIFYING AND TRACKING DIGITAL CERTIFICATES FOR SECURE INTERFACING IN A DISTRIBUTED NETWORK

(71) Applicant: BANK OF AMERICA CORPORATION, CHARLOTTE, NC (US)

(72) Inventors: Kamal D. Sharma, Mason, OH (US); Michael J. Richardson, Northbrook, IL (US); Ashwini Hosbet, Plano, TX (US); Bhavna Agrawal, Plano, TX (US); Himanshu Paliwal, Edison, NJ (US)

(73) Assignee: BANK OF AMERICA CORPORATION, CHARLOTTE, NC (US)

(21) Appl. No.: 18/944,905

(22) Filed: Nov. 12, 2024

(51) Int. Cl. H04L 9/32

(52) U.S. Cl. CPC H04L 9/3268

(57) ABSTRACT

Systems, computer program products, and methods are described herein for identifying and tracking digital certificates for secure interfacing in a distributed network. The present disclosure is configured to generate a certificate reader component, wherein the certificate reader component is coupled to at least one host server; identify, by the certificate reader component, at least one digital certificate applied to the at least one host server; automatically collect digital certificate data for the at least one digital certificate; generate a digital certificate database comprising the collected digital certificate data for the at least one digital certificate; receive a query for the digital certificate database, wherein the query comprises at least one of a digital certificate identifier, a website identifier, an application identifier, or a host identifier; and generate, based on the query, a report interface component, wherein the report interface component comprises the collected digital certificate data based on the query.

### TECHNOLOGICAL FIELD

Example embodiments of the present disclosure relate to the identification and tracking of digital certificates for secure interfacing in a distributed network.

### BACKGROUND

In a distributed network of host servers, these host servers are often tasked with storing different applications and websites, and the content of each website and application. These host servers, in addition to storing the applications and/or websites, also host each application's and/or website's digital certificate (e.g., secure socket layer (SSL) certificate) to ensure a secure connection between a web browser and the host server to download the content of the requested application or website. However, difficulties arise for these digital certificates when the digital certificates need to be accurately and efficiently tracked throughout the distributed network as these digital certificates are difficult to identify, difficult to identify after they have expired or are dead, and difficult to track which applications or websites are hosted on which servers and with which digital certificates. Thus, there is a need for a system or method that can accurately, efficiently, and securely identify and track digital certificates used for secure interfacing (between host servers and web browsers) in a distributed network.

Applicant has identified a number of deficiencies and problems associated with identifying and tracking digital certificates across host servers, including alive and dead digital certificates. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for identifying and tracking digital certificates for secure interfacing in a distributed network.

In one aspect, a system for identifying and tracking digital certificates for secure interfacing in a distributed network is provided. In some embodiments, the system may comprise: a memory device with computer-readable program code stored thereon; at least one processing device operatively coupled to the at least one memory device and the at least one communication device, wherein executing the computer-readable code is configured to cause the at least one processing device to: generate a certificate reader component, wherein the certificate reader component is coupled to at least one host server; identify, by the certificate reader component, at least one digital certificate applied to the at least one host server; automatically collect digital certificate data for the at least one digital certificate; generate a digital certificate database comprising the collected digital certificate data for the at least one digital certificate; receive a query for the digital certificate database, wherein the query comprises at least one of a digital certificate identifier, a website identifier, an application identifier, or a host identifier; and generate, based on the query, a report interface component, wherein the report interface component comprises the collected digital certificate data for at least one of the digital certificate identifier, the website identifier, the application identifier, or the host identifier.

In some embodiments, the certificate reader component is coupled to a public key infrastructure component associated with the at least one host server.

In some embodiments, the at least one digital certificate is associated with at least one application or website hosted on the at least one host server.

In some embodiments, the identification of the at least one digital certificate by the certificate reader component is identified in real-time to the application of the at least one digital certificate to the at least one host server.

In some embodiments, executing the computer-readable code is further configured to cause the at least one processing device to: identify at least one application associated with the identified at least one digital certificate; identify a plurality of host servers hosting the at least one application; and update the digital certificate database with a plurality of host server identifiers associated with the plurality of host servers.

In some embodiments, the certificate reader component identifies all digital certificates hosted on the at least one host server.

In some embodiments, the collected digital certificate data comprises at least one of an expiration for the at least one digital certificate, at least one of an application identifier or a website identifier for the at least one digital certificate, at least one of a website public key or an application public key for the at least one digital certificate, or at least one of a live status or a dead status for the at least one digital certificate.

In some embodiments, executing the computer-readable code is further configured to cause the at least one processing device to: scan, by the certificate reader component, the at least one host server, wherein the scan is a full file system scan of the at least one host server; automatically collect, based on the scan of the at least one host server, live digital certificate data and historical digital certificate data; and update the digital certificate database with the live digital certificate data and the historical digital certificate data associated with the at least one host server. In some embodiments, the at least one host server scanned is a network comprising the at least one host server, and wherein the scan is a full file system scan of the network. In some embodiments, the network scanned comprises a range of networks, and wherein the range of networks is based on a range of internet protocol (IP) addresses. In some embodiments, the certificate reader component scans the network at a pre-determined interval. In some embodiments, executing the computer-readable code is further configured to cause the at least one processing device to: validate the collected digital certificate data that was previously collected by the digital certificate component by comparing the live digital certificate data and historical digital certificate data of the at least one host server.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for identifying and tracking digital certificates for secure interfacing in a distributed network, in accordance with an embodiment of the disclosure;

FIG. 2 illustrates a process flow for identifying and tracking digital certificates for secure interfacing in a distributed network, in accordance with an embodiment of the disclosure;

FIG. 3 illustrates a process flow for updating the digital certificate database with a plurality of host servers associated with each identified digital certificate(s), in accordance with an embodiment of the disclosure;

FIG. 4 illustrates a process flow for validating collected digital certificate data based on a full file system scan within a network or network range, in accordance with an embodiment of the disclosure; and

FIG. 5 illustrates an exemplary user interface indicating the host server or storage component that stores the file scanned by the certificate reader component, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In a distributed network of host servers, these host servers are often tasked with storing different applications and websites, and the content of each website and application. These host servers, in addition to storing the applications and/or websites, also host each application's and/or website's digital certificate (e.g., secure socket layer (SSL) certificate) to ensure a secure connection between a web browser and the host server to download the content of the requested application or website. However, difficulties arise for these digital certificates when the digital certificates need to be accurately and efficiently tracked throughout the distributed network as these digital certificates are difficult to identify, difficult to identify after they have expired or are dead, and difficult to track which applications or websites are hosted on which servers and with which digital certificates. Thus, there is a need for a system or method that can accurately, efficiently, and securely identify and track digital certificates used for secure interfacing (between host servers and web browsers) in a distributed network.

Accordingly, the present disclosure provides a system, computer program product, or computer implemented method for identifying and tracking digital certificates for secure interfacing in a distributed network. In such embodiments, and as described herein, the disclosure allows for the generation of a certificate reader component, wherein the certificate reader component is coupled to at least one host server; the identification, by the certificate reader component, of at least one digital certificate applied to the at least one host server; and the automatic collection of digital certificate data for the at least one digital certificate. Further, the disclosure provides for the generation of a digital certificate database comprising the collected digital certificate data for the at least one digital certificate; the receipt of a query for the digital certificate database, wherein the query comprises at least one of a digital certificate identifier, a website identifier, an application identifier, or a host identifier; and the generation, based on the query, of a report interface component, wherein the report interface component comprises the collected digital certificate data for at least one of the digital certificate identifier, the website identifier, the application identifier, or the host identifier.

Additionally, and in some embodiments, the disclosure may further provides a scan, by the certificate reader component, of the at least one host server (or a network of host servers) wherein the scan is a full file system scan of the at least one host server (or network of host servers); the automatic collection, based on the scan of the at least one host server, of live digital certificate data and historical (or dead) digital certificate data; and the update of the digital certificate database with the live digital certificate data and the historical (e.g., dead) digital certificate data associated with the at least one host server (or network of servers).

In other words, the disclosure provides a system for identifying and tracking digital files (e.g., SSL certificates) for establishing secure connections in an electronic environment (e.g., between web browsers and host servers). The system may access host servers, using a certificate reader component, to analyze each of the digital certificates currently deployed and active on the host server, and/or may access host servers and perform a full system scan to determine all of the current and previous (or dead) digital certificates that have ever been hosted on the host server. In some embodiments, the system may look at a common certificate name for the digital certificate and a list of potential host names the digital certificate is already likely deployed on and active, and determines if there are any matches in the host's logs against the common certificate names. Additionally, and given a network target range of host servers to analyze, the system may also perform full network scans (which may further comprise full file system scans) to identify all the certificates on the hosts in the target network. Lastly, the system may generate reports showing all the hosts that previously or currently had the SSL certificate(s) deployed. In some embodiments, such reports may comprise only the information requested in a query by a user device associated with the system, such that only specific data is transmitted across a network (e.g., a listing of all the host servers currently storing specific digital certificates for a website or application, a listing of all the alive and dead digital certificates for a host server or network of host servers, a listing of all the host servers that need to be updated with new digital certificates, and/or the like), which in turn may save on data transmission length or size, improve processing speed (e.g., by only requiring processing of certain data from the digital certificate database using the specific data in the query request), and improve graphical user interface configurations (e.g., by only showing the specific requested data).

What is more, the present disclosure provides a technical solution to a technical problem. As described herein, the technical problem includes the identification and tracking of digital certificates across host servers, including alive and dead digital certificates. The technical solution presented herein allows for the accurate and full identification, tracking, and in some embodiments reporting, of digital certificates throughout a distributed network. In some embodiments, the technical solution provided above may further be used to accurately and efficiently identify each of the host servers that need to be updated with new digital certificates (e.g., where a previous digital certificate is no longer secure and has been hacked by a man in the middle attack, or where an SSL certificate meets its expiration period, and/or the like), and/or accurately and efficiently track previous dead digital certificates that may still be used to make the website or application vulnerable to cyber-attacks (e.g., such as where a client is using a dead SSL certificate to access a website or application). In particular, the solution provided herein is an improvement over existing solutions to the tracking and identification of alive and dead digital certificates, (i) with fewer steps to achieve the solution, thus reducing the amount of computing resources, such as processing resources, storage resources, network resources, and/or the like, that are being used (e.g., by analyzing each digital certificate as the digital certificates are generated or transmitted, and/or by performing full system scans to validate and fill in data regarding alive and dead digital certificates for each host server); (ii) providing a more accurate solution to problem, thus reducing the number of resources required to remedy any errors made due to a less accurate solution (e.g., by using the certificate reader component to analyze each host server and their digital certificates, and by generating and/or updating a digital certificate database with digital certificate data); (iii) removing manual input and waste from the implementation of the solution, thus improving speed and efficiency of the process and conserving computing resources (e.g., by analyzing each host server and/or network of host servers automatically and with the certificate reader component or full file system scans, the disclosure provides a completely automatic solution to the above-identified problem, and further by validating the current digital certificate database information using these methods, the system removes/updates incorrect or out of date data regularly); (iv) determining an optimal amount of resources that need to be used to implement the solution, thus reducing network traffic and load on existing computing resources (e.g., by transmitting data requested in the query, which is specific to the request in the query, the disclosure allows for an optimal or least amount of data to be transmitted over a network). Furthermore, the technical solution described herein uses a rigorous, computerized process to perform specific tasks and/or activities that were not previously performed. In specific implementations, the technical solution bypasses a series of steps previously implemented, thus further conserving computing resources.

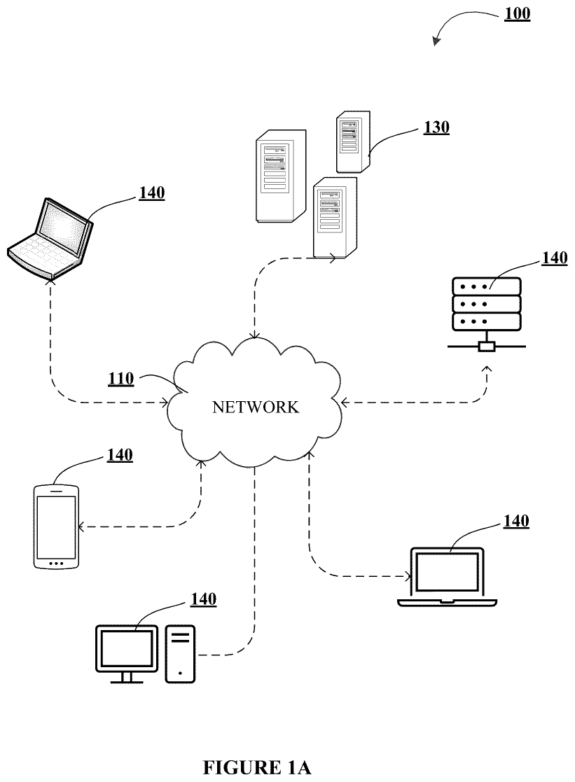

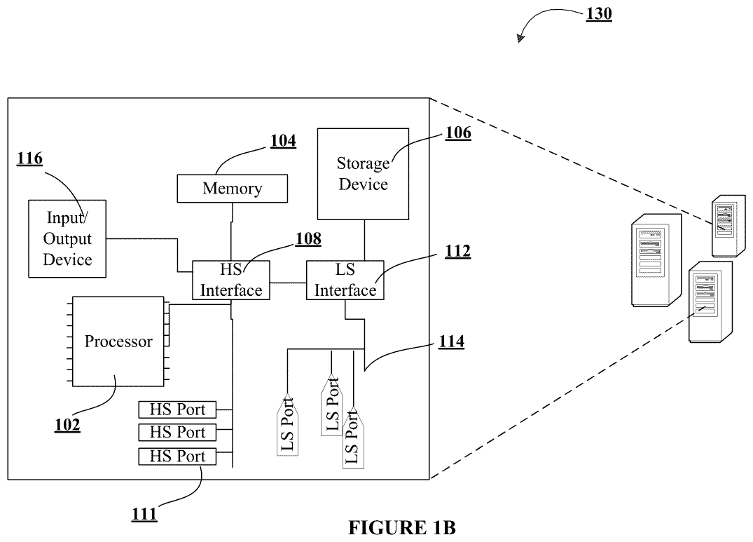

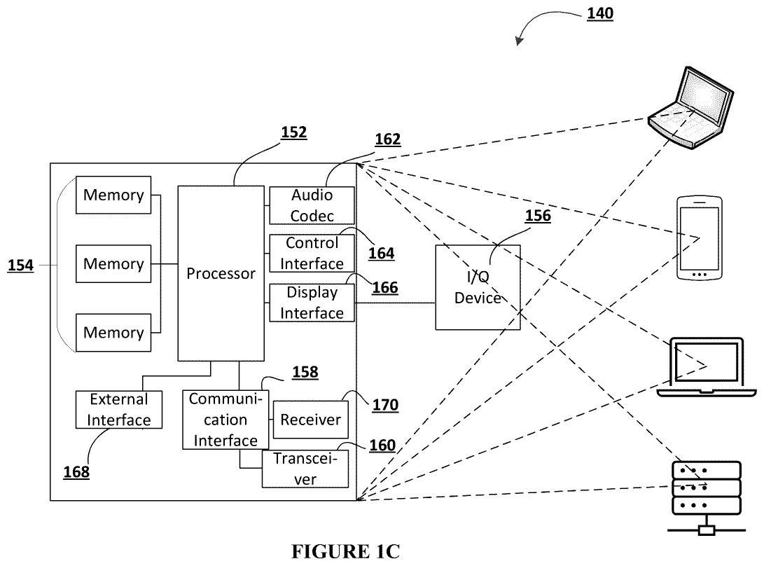

FIGS. 1A-1C illustrate technical components of an exemplary distributed computing environment for identifying and tracking digital certificates for secure interfacing in a distributed network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

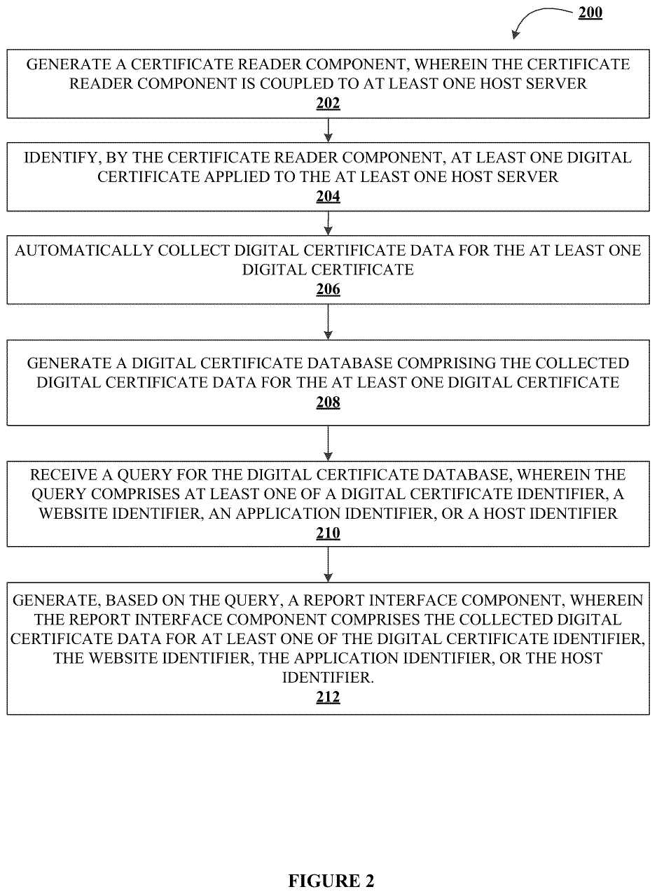

FIG. 2 illustrates a process flow 200 for identifying and tracking digital certificates for secure interfacing in a distributed network, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of generating a certificate reader component, wherein the certificate reader component is coupled to at least one host server. For instance, and as used herein, a certificate reader component is a tool configured within the system to identify and analyze digital certificates within a host server. Additionally, and as used herein, the term “digital certificate” refers to a certificate or private key stored on a host server (e.g., a secure sockets layer (SSL) certificate). Thus, and in some embodiments, the at least one digital certificate is associated with at least one application or website hosted on the at least one host server. For instance, such a certificate reader component may comprise a processing device operatively coupled to a memory device and a communication, where computer-readable code is configured to cause the processing device to at least identify and analyze each digital certificate within each accessed host server and/or network of host servers.

As used herein, a “host server” refers to a server configured to host websites, applications, and/or the like by providing storage space for the website content and/or application content, on a server which may be stored and/or located at a physical location (e.g., a data center, and/or the like). Thus, such host servers are provided to maintain, store, and run the resources needed to build and run a website or an application. Further, and in some such embodiments, a host server may host or store a digital certificate (i.e., an SSL certificate), which may allow for a secure protocol which establishes a connection between a web browser and the website (or application) host server to access the content of the website (or application). Additionally, and as used herein, the host servers described herein may comprise internal facing hosts and/or external facing hosts, and thus, the processes described herein are meant to cover both instances within a firewall associated with a network and outside a firewall associated with a network. Thus, and by scanning both the internal facing host servers and the external facing host servers, the system may accurately and efficiently protect the network from potential internal and external threats and improve network security.

Further, and in some such embodiments, the certificate reader component may be coupled to at least one host server. For instance, the certificate reader component may be operatively coupled with at least one host server, or a plurality of host servers (e.g., within a network, network range, and/or the like), whereby the certificate reader component may access the digital certificates stored on the host server(s). Additionally, and in some embodiments, the phrase “operatively coupled” may refer to a wired or wireless connection between the host server(s) and the certificate reader component, such that certificate reader component may receive data from the host server(s). In some embodiments, the certificate reader component is coupled to a public key infrastructure (PKI) component associated with the at least one host server. For instance, and in some such embodiments, the PKI component may refer to a tool used to create and manage public keys (e.g., web browser or application public keys) for encryption. Thus, and in some such embodiments, the certificate reader component may be integrated with the PKI component in a web browser or application browser, such that as the PKI is used to establish a secure connection with the digital certificate, the certificate reader component may access, identify, and collect the data of each digital certificate.

As shown in block 204, the process flow 200 may include the step of identifying, by the certificate reader component, at least one digital certificate applied to the at least one host server. For instance, the system may identify each digital certificate associated with each host server accessed by the certificate reader component. In some embodiments, the certificate reader component may be associated with a plurality of host servers, and/or a singular certificate reader component may be associated with a specific, singular host server. Additionally, and as described briefly above, the at least one digital certificate identified by the certificate reader component may be identified based on accessing the associated host server which stores the at least one digital certificate.

In some embodiments, the system may identify a host server (or network of host servers) to access by a certificate reader component based on receiving a host server identifier from a user device indicating that a user associated with the user device would like to know what digital certificates are stored on the host server. In some embodiments, the system may identify a host server (or network of host servers) based on identifying a host server (or network of host servers) that have not yet been analyzed or have not been analyzed within a pre-defined interval (e.g., within the past day, seven days, 15 days, month, six months, year, and/or the like).

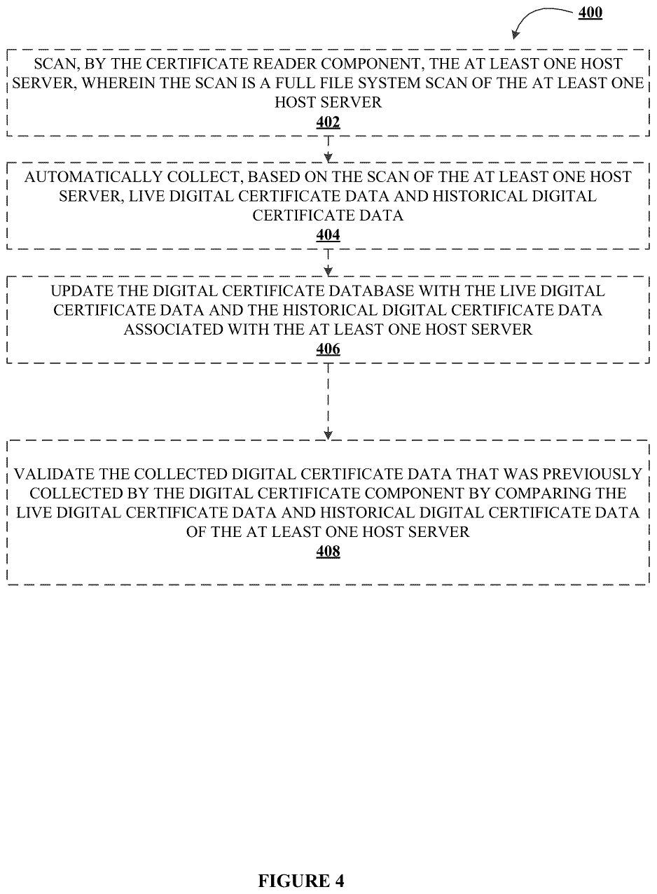

In some embodiments, the certificate reader component may identify all the digital certificates hosted on the at least one host server. Thus, and in some embodiments, the certificate reader component may identify each of the live digital certificates currently stored on the host server(s), and/or in some embodiments, the expired and/or dead digital certificates on the host server(s). Such embodiments of identifying expired and/or dead digital certificates are described in further detail hereinbelow with respect to FIG. 4.

In some embodiments, the identification of the at least one digital certificate by the certificate reader component is identified in real-time to the application of the at least one digital certificate to the at least one host server. Thus, and in such an embodiment, the system—using the certificate reader component—may identify the digital certificates as they are applied or stored at the host server, in real time. For instance, and in some embodiments, as the certificate reader component is coupled with the host server(s), the certificate reader component may access each digital certificate as the digital certificate is transmitted to and stored by the host server(s). In this manner, the certificate reader component may sit on top of the host server and access each digital certificate as each digital certificate is stored in real time or near real time.

In some embodiments, the system may look at a common certificate name for the digital certificate and a list of potential host names the digital certificate is already likely deployed on and active, and the system may determine if there are any matches in the host's logs against the common certificate names. In this manner, the system may determine which host servers to access given a specific digital certificate or common certificate name (e.g., the digital certificate may first be identified, and from the digital certificate, at least one host potential host server that is likely hosting the digital certificate may be identified for analysis). In some embodiments, such a listing of potential host names may be stored in a database associated with the system (e.g., a digital certificate database, a potential digital certificate database with likely host servers that need to be validated as hosting the digital certificates, and/or the like). Thus, and in some embodiments, the system may access this database to gather information regarding which host servers need to be validated or confirmed as hosting the identified digital certificate. In some embodiments, and during the process of validating or confirming the host server hosts the identified digital certificate, the system may analyze all the digital certificates on the host server and compile a list of active (or in some instances, inactive/dead) digital certificates from the host server, which may then be used to generate or update a digital certificate database.

As shown in block 206, the process flow 200 may include the step of automatically collecting digital certificate data for the at least one digital certificate. For example, the system may automatically collect digital certificate data associated with the digital certificate(s) of the host server(s), whereby the digital certificate data comprises the information regarding the digital certificate and/or its associated website or application. For instance, and in some embodiments, the digital certificate data may comprise an expiration for the at least one digital certificate (e.g., which may occur when a digital certificate's expiration is known ahead of the expiration period), a date of issues or generation for the digital certificate, at least one of an application identifier or a website identifier for the at least one digital certificate (e.g., a unique identifier or name of the website and/or application), at least one of a website public key or an application public key for the at least one digital certificate, and/or at least one of a live status or a dead status for the at least one digital certificate. In some embodiments, an expiration of a digital certificate may be based on a date the digital certificate was issued to the host server and/or a date the digital certificate was generated. In some embodiments, the expiration of the digital certificate may comprise a period of 365 days from the date the digital certificate was generated and/or issued, 395 days from the date the digital certificate was generated and/or issues, 398 days from the date the digital certificate was generated and/or issues, and/or the like.

In some embodiments, the system may automatically collect the digital certificate data upon accessing the host server(s), when the certificate reader component accesses the host server(s). In some embodiments, the system may collect all the data of each digital certificate in the host server(s). In some embodiments, and alternatively, the system may collect only the data provided above for the digital certificate data. In some embodiments, such data from the digital certificate may be organized in a non-standard format, such that the system (e.g., using the certificate reader component) may identify each piece of data within the digital certificate, parse each piece of data, and identify which pieces of data are pertinent and associated with the digital certificate data identified above. In some such embodiments, a natural language processing (NLP) component may be applied by the system to identify each piece of data and determine which data to collect from the host server(s).

As shown in block 208, the process flow 200 may include the step of generating a digital certificate database comprising the collected digital certificate data for the at least one digital certificate. In some embodiments, the system may generate a digital certificate database comprising the collected digital certificate data which may be organized based on the digital certificates used in one or more host servers. For instance, and where an application or website is hosted on multiple host servers, and where the application and/or website shares the same digital certificate, the host servers hosting the application or website may also comprise the same digital certificate (i.e., a shared digital certificate). Further, and based on this shared digital certificate, the digital certificate database may show each digital certificate and which host server(s) are hosting each digital certificate, and the data of each website or application associated with each digital certificate, and/or the like. Thus, and in some embodiments, the digital certificate database may organize the digital certificate data around each digital certificate (e.g., a shared digital certificate may be listed once in the digital certificate database, and each host server hosting the shared certificate and the associated website and/or application data may be linked to the shared digital certificate). In similar embodiments, the digital certificate database may additionally and/or alternatively organize its digital certificate data based on a query received by the system, which may identify a piece of the digital certificate data a user may wish to view.

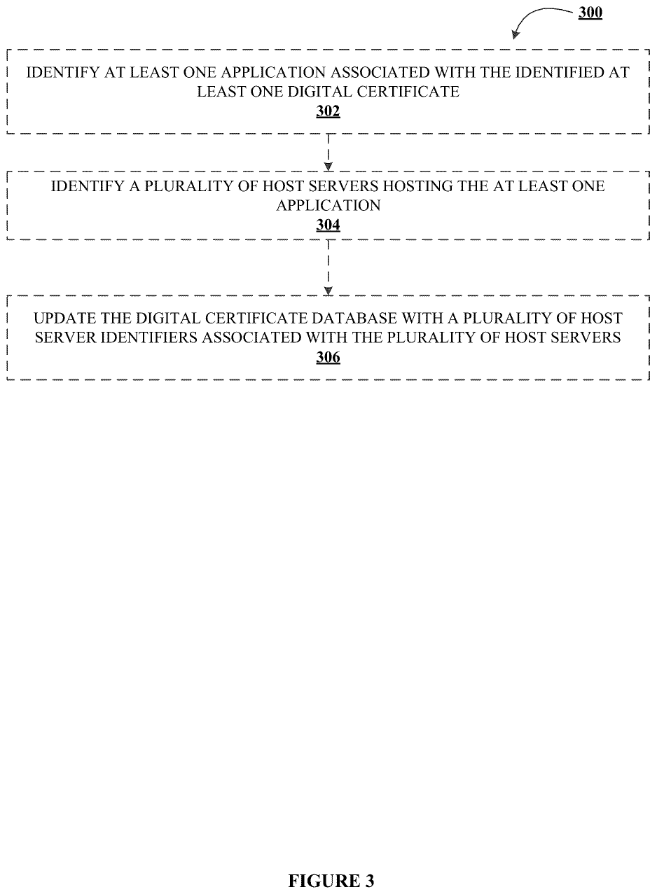

In some embodiments, the digital certificate database may comprise the digital certificate data organized in a table, a map of nodes, and/or the like, whereby the digital certificate database may be queried to gather specific data associated with a website or application, a digital certificate name or identifier, a host server identifier or name, live or dead attribute(s) (e.g., indicating whether the digital certificate is currently alive and in use by a host server or dead and no longer in use by a host server), and/or the like. In some embodiments, the digital certificate database may be regularly and/or periodically updated by periodically running the process described hereinabove and/or described below with respect to FIGS. 3 and 4. In some embodiments, the digital certificate database may be validated based on the periodic review of the host server(s) by the certificate reader component and periodic update of the digital certificate database as the digital certificates and the digital certificate data changes between periods of running the process described herein (and in FIGS. 3 and 4).

As shown in block 210, the process flow 200 may include the step of receiving a query for the digital certificate database, wherein the query comprises at least one of a digital certificate identifier, a website identifier, an application identifier, or a host identifier. For example, the system may receive a query from a user device (e.g., a user device associated with a user of the system, a user device associated with a manager of the at least one host server, a user device associated with a manager or owner of the website or application using the at least one host server, and/or the like), from a manager of the system (e.g., a user device associated with a manager of the system), from the system itself (e.g., a periodic query to determine when the latest analysis of the host server was completed), and/or the like.

In some embodiments, the query may comprise a host server identifier or name, a host server name or identifier, an application identifier or website identifier, and/or the like. Thus, and in some such embodiments, the query may be used by the system to identify specific digital certificate data within the digital certificate database, which may comprise all the related data of a specific digital certificate and/or only a portion of the digital certificate data, data related to a specific host server (e.g., all historical and current digital certificates, and/or the like), data related to a specific website or application (e.g., all the digital certificates and host servers used by currently and/or historically by the website or application), and/or the like. Thus, and in some embodiments, and based on the request within the query for specific portions of data, the system may only gather specific data from the digital certificate database that is needed to answer the query request, which may in turn save on computing resources, increase processing speed, and save on data transmission length or size.

As shown in block 212, the process flow 200 may include the step of generating, based on the query, a report interface component, wherein the report interface component comprises the collected digital certificate data for at least one of the digital certificate identifier, a website identifier, an application identifier, or a host identifier. For example, the system may generate a report interface component which comprises the data collected from the digital certificate database related to the query (e.g., the digital certificate identifier and the related data, a website identifier and the related data, an application identifier and the related data, a host identifier and the related data, and/or the like). Thus, and in some such embodiments, the report interface component may comprise computer readable data which is configured in a network transmissible format across a network to a user device, and may be used to configure a graphical user interface (GUI) of the user device to show the data within the report interface component in a human-readable format (e.g., show the information requested in the query to the user). In some embodiments, the user device that receives the report interface component may be the same user device that generated and/or transmitted the query to the system. In some embodiments, the report interface component may automatically trigger the configuration of the GUI to show the information of the report interface component as a pop up on the user device's GUI.

FIG. 3 illustrates a process flow 300 for updating the digital certificate database with a plurality of host servers associated with each identified digital certificate(s), in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of identifying at least one application associated with the identified at least one digital certificate. For example, and in some such embodiments, the system may identify at least one application associated with the digital certificate that was identified in FIG. 2. For instance, the system may identify an application for each digital certificate identified in the host server(s), where each application may be identified based on an application identifier, http address, application or website name, and/or the like. Upon identifying the application associated with the digital certificate(s) on the host server, the system may use the application identifier, website name or application name, http address, and/or the like, to identify the other host server(s) that host the same application or website.

In some embodiments, the system may identify other host server(s) that stores the same application or website content data identified by analyzing a plurality of host servers in the same network and identifying which host servers in the network store the application or website content data, and thus the same digital certificate.

In some embodiments, and as shown in block 304, the process flow 300 may include the step of identifying a plurality of host servers hosting the at least one application. For example, and in some embodiments, the system may identify a plurality of host servers that are hosting the same application or website, and thus, identify the shared digital certificate that was already identified in the originally identified host server (e.g., in blocks 202-204). Thus, and in such an embodiment, the system may actively and automatically determine which host servers share the same digital certificates for each website or application. In some embodiments, such an identification of the plurality of host servers may be done by the system using the same process described above with respect to FIG. 2. In some embodiments, the system may receive a list or identify a list of host server(s) that host the same website or application from the original host server identified, which may comprise a listing of each related host server that also hosts the same application(s) or website(s) as the originally identified host server.

In some embodiments, and as shown in block 306, the process flow 300 may include the step of updating the digital certificate database with a plurality of host server identifiers associated with the plurality of host servers. For example, and in some such embodiments, the system may update the digital certificate database with the plurality of host server identifiers that also host the same application or website as the originally identified application or website. In this manner, the digital certificate database may comprise an exhaustive list of each of the host servers that host each website and/or application, and the digital certificates for each host server.

FIG. 4 illustrates a process flow 400 for validating collected digital certificate data based on a full file system scan within a network or network range, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of scanning, by the certificate reader component, the at least one host server, wherein the scan is a full file system scan of the at least one host server. For instance, and in such an embodiment, the system may fully scan—by the certificate reader component—the at least one host server, whereby the full scan may scan each of the files stored in the host server and determine all current and historical digital certificates and all the current and historical digital certificate data. For instance, the certificate reader component may scan each file stored in the host server, such as but not limited to .pem files (e.g., a Privacy Enhanced Mail file comprising SSL certificates and keys, which may have been used initially to import a plurality of SSL certificates as a single file), .crt files (e.g., which may comprise an SSL certificate and transport layer security TLS certificate, which may include both the public and private keys for network communication between the user device and the host server), and/or the like. In this manner, the certificate reader component may gather all the digital certificates that are currently live on the host server, and all the historical or dead digital certificates that were in use—at one time—on the host server. In some embodiments, the full file system scan may scan all the protected and unprotected files on the host server to gather the digital certificates (alive and dead) and the digital certificate data (for alive and dead digital certificates).

In some embodiments, the at least one host server scanned is a network comprising the at least one host server, and wherein the scan is a full file system scan of the network. For example, and in some embodiments, the at least one host server scanned may be a network that comprises a plurality of host servers (which may include the host server of block 402). Thus, and in some such embodiments, each of the host servers within the network may be fully scanned by using a full file system scan on each host server in the network. In some embodiments, and where the at least one host server scanned is a network, the network scanned may comprise a range of networks, and the range of networks may be based on a range of internet protocol (IP) addresses. For example, and in such an embodiment, the system may identify a range of IP addresses which identifies an associated range of host servers that should be scanned within the network.

In some embodiments, the certificate reader component may scan the network of host servers and/or each, individual host server, at a pre-determined interval. In this manner, the system may regularly scan the network, and/or each host server, to regularly update the digital certificate database with the updated digital certificates and/or the digital certificate data. In some embodiments, the pre-determined interval may be pre-determined by a manager of the system, by a manager of the host server(s) and/or network(s), by the system itself (e.g., based on determined patterns of updates to digital certificates), and/or the like.

In some embodiments, and as shown in block 404, the process flow 400 may include the step of automatically collecting, based on the scan of the at least one host server, live digital certificate data and historical digital certificate data. For example, and in some embodiments, the system may automatically collect—based on the scan of the host server(s) and/or the network(s)—the digital certificates (alive and dead) and/or digital certificate data (for alive and dead digital certificates). Such current and historical digital certificate data may be the same or similar types of digital certificate data s that described above with respect to FIG. 2.

In some embodiments, and as shown in block 406, the process flow 400 may include the step of updating the digital certificate database with the live digital certificate data and the historical digital certificate data associated with the at least one host server. For example, and in some embodiments, the system may update the digital certificate database in real time or near real time to collecting the live digital certificate data and historical digital certificate data for the host server(s) and/or the network(s).

In some embodiments, and as shown in block 408, the process flow 400 may include the step of validating the collected digital certificate data that was previously collected by the digital certificate component by comparing the live digital certificate data and historical digital certificate data of the at least one host server. For example, and in some such embodiments, the system may validate the previously collected digital certificate data that was used to generate and/or previously update the digital certificate database, whereby the validation of the previously collected digital certificate data may be determined as still accurate or correct (e.g., all alive digital certificate in the previously collected digital certificate data are still alive) or may be determined to need to correction (e.g., some or all of the alive digital certificates in the previously collected digital certificate data are now expired or dead and have been updated on the host servers with new digital certificates). Thus, and in this manner, the system may keep an up to date and accurate report of all the alive and dead digital certificates in a distributed network environment which may comprise a plurality of host servers for a plurality of applications or websites.

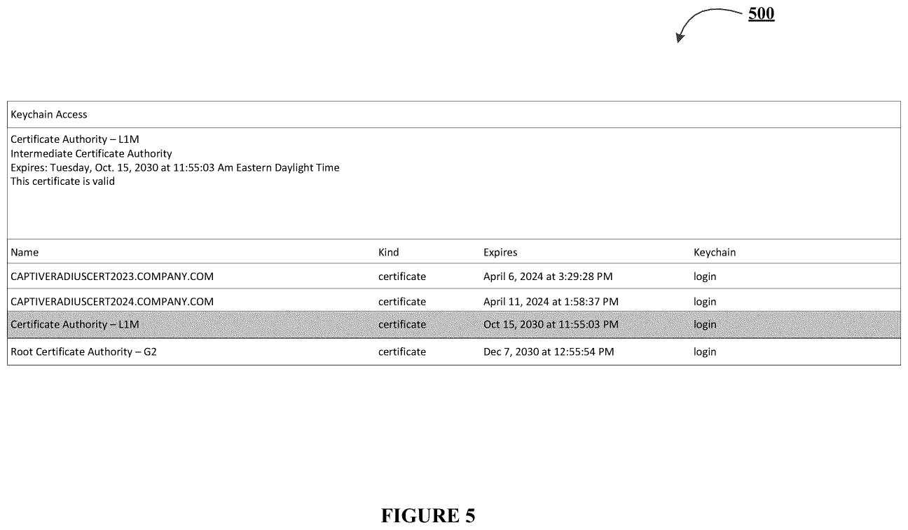

FIG. 5 illustrates an exemplary user interface 500 indicating the host server or storage component that stores the file scanned by the certificate reader component, in accordance with an embodiment of the disclosure. In some embodiments, a system (e.g., similar to one or more of the systems described herein with respect to FIGS. 1A-1C) may perform one or more of the steps for generating and/or scanning the storage component(s) associated with user interface 500. For example, a system (e.g., the system 130 described herein with respect to FIG. 1A-1C) may perform the steps generating and/or scanning the storage component(s) associated with user interface 500.

Thus, and as shown in exemplary user interface (UI) 500, the system—using the certificate reader component—to scan a storage component that stores the file that will be scanned. For example, and in some embodiments, the system may scan a website that is associated with a storage component that stores a file comprising the digital certificate, such as but not limited to a certificate authority website, which may comprise the capability to validate the digital identity and digital certificates of its associated websites, email addresses, and/or the like, and host server(s). Thus, and as shown herein, the exemplary UI 500 may be configured on a user device associated with the system, and may be configured to show the user of the user device the digital certificates associated with a host server/website, each digital certificate's expiration period, and whether each digital certificate is valid. Further, and as shown in the exemplary UI 500, the system may further show the expired or invalid digital certificates used previously at the host server (e.g., shown as “CAPTIVERADIUSCERT2023.COMPANY. COM which previously expired Apr. 6, 2024, at 3:29:28 PM).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for identifying and tracking digital certificates for secure interfacing in a distributed network, the system comprising:
a memory device with computer-readable program code stored thereon;
at least one processing device operatively coupled to the at least one memory device and the at least one communication device, wherein executing the computer-readable code is configured to cause the at least one processing device to:
generate a certificate reader component, wherein the certificate reader component is coupled to at least one host server;
identify, by the certificate reader component, at least one digital certificate applied to the at least one host server;
automatically collect digital certificate data for the at least one digital certificate;
generate a digital certificate database comprising the collected digital certificate data for the at least one digital certificate;
receive a query for the digital certificate database, wherein the query comprises at least one of a digital certificate identifier, a website identifier, an application identifier, or a host identifier; and
generate, based on the query, a report interface component, wherein the report interface component comprises the collected digital certificate data for at least one of the digital certificate identifier, the website identifier, the application identifier, or the host identifier.

2. The system of claim 1, wherein the certificate reader component is coupled to a public key infrastructure component associated with the at least one host server.

3. The system of claim 1, wherein the at least one digital certificate is associated with at least one application or website hosted on the at least one host server.

4. The system of claim 1, wherein the identification of the at least one digital certificate by the certificate reader component is identified in real-time to the application of the at least one digital certificate to the at least one host server.

5. The system of claim 1, wherein executing the computer-readable code is further configured to cause the at least one processing device to:
identify at least one application associated with the identified at least one digital certificate;
identify a plurality of host servers hosting the at least one application; and
update the digital certificate database with a plurality of host server identifiers associated with the plurality of host servers.

6. The system of claim 1, wherein the certificate reader component identifies all digital certificates hosted on the at least one host server.

7. The system of claim 1, wherein the collected digital certificate data comprises at least one of an expiration for the at least one digital certificate, at least one of an application identifier or a website identifier for the at least one digital certificate, at least one of a website public key or an application public key for the at least one digital certificate, or at least one of a live status or a dead status for the at least one digital certificate.

8. The system of claim 1, wherein executing the computer-readable code is further configured to cause the at least one processing device to:
scan, by the certificate reader component, the at least one host server, wherein the scan is a full file system scan of the at least one host server;
automatically collect, based on the scan of the at least one host server, live digital certificate data and historical digital certificate data; and
update the digital certificate database with the live digital certificate data and the historical digital certificate data associated with the at least one host server.

9. The system of claim 8, wherein the at least one host server scanned is a network comprising the at least one host server, and wherein the scan is a full file system scan of the network.

10. The system of claim 9, wherein the network scanned comprises a range of networks, and wherein the range of networks is based on a range of internet protocol (IP) addresses.

11. The system of claim 8, wherein the certificate reader component scans the network at a pre-determined interval.

12. The system of claim 8, wherein executing the computer-readable code is further configured to cause the at least one processing device to:
validate the collected digital certificate data that was previously collected by the digital certificate component by comparing the live digital certificate data and historical digital certificate data of the at least one host server.

13. A computer program product for identifying and tracking digital certificates for secure interfacing in a distributed network, wherein the computer program product comprises at least one non-transitory computer-readable medium having computer-readable program code portions embodied therein, the computer-readable program code portions which when executed by a processing device are configured to cause the processor to:
generate a certificate reader component, wherein the certificate reader component is coupled to at least one host server;
identify, by the certificate reader component, at least one digital certificate applied to the at least one host server;
automatically collect digital certificate data for the at least one digital certificate;
generate a digital certificate database comprising the collected digital certificate data for the at least one digital certificate;
receive a query for the digital certificate database, wherein the query comprises at least one of a digital certificate identifier, a website identifier, an application identifier, or a host identifier; and
generate, based on the query, a report interface component, wherein the report interface component comprises the collected digital certificate data for at least one of the digital certificate identifier, the website identifier, the application identifier, or the host identifier.

14. The computer program product of claim 13, wherein the certificate reader component is coupled to a public key infrastructure component associated with the at least one host server.

15. The computer program product of claim 13, wherein the identification of the at least one digital certificate by the certificate reader component is identified in real-time to the application of the at least one digital certificate to the at least one host server.

16. The computer program product of claim 13, wherein the computer-readable program code portions which when executed by the processing device are further configured to cause the processor to:
identify at least one application associated with the identified at least one digital certificate;
identify a plurality of host servers hosting the at least one application; and
update the digital certificate database with a plurality of host server identifiers associated with the plurality of host servers.

17. The computer program product of claim 13, wherein the computer-readable program code portions which when executed by the processing device are further configured to cause the processor to:
scan, by the certificate reader component, the at least one host server, wherein the scan is a full file system scan of the at least one host server;
automatically collect, based on the scan of the at least one host server, live digital certificate data and historical digital certificate data; and
update the digital certificate database with the live digital certificate data and the historical digital certificate data associated with the at least one host server.

18. A computer implemented method for identifying and tracking digital certificates for secure interfacing in a distributed network, the computer-implemented method comprising:
generating a certificate reader component, wherein the certificate reader component is coupled to at least one host server;
identifying, by the certificate reader component, at least one digital certificate applied to the at least one host server;
automatically collecting digital certificate data for the at least one digital certificate;
generating a digital certificate database comprising the collected digital certificate data for the at least one digital certificate;
receiving a query for the digital certificate database, wherein the query comprises at least one of a digital certificate identifier, a website identifier, an application identifier, or a host identifier; and
generating, based on the query, a report interface component, wherein the report interface component comprises the collected digital certificate data for at least one of the digital certificate identifier, the website identifier, the application identifier, or the host identifier.

19. The computer implemented method of claim 18, wherein the certificate reader component is coupled to a public key infrastructure component associated with the at least one host server.

20. The computer implemented method of claim 18, further comprising:
scanning, by the certificate reader component, the at least one host server, wherein the scan is a full file system scan of the at least one host server;
automatically collecting, based on the scan of the at least one host server, live digital certificate data and historical digital certificate data; and
updating the digital certificate database with the live digital certificate data and the historical digital certificate data associated with the at least one host server.
